(19) United States
(12) Patent Application Publication
(10) Pub. No.: US 2004/0247975 A1
(43) Pub. Date: Dec. 9, 2004

(54) Composite polymeric electrolyte membrane, preparation method thereof

(76) Inventors: Min-Kyu Song, Seoul (KR); Hee-Woo Rhee, Seoul (KR); Young-Taek Kim, Seoul (KR)

Correspondence Address: Abelman Frayne & Schwab, 150 East 42nd Street, New York, NY, 10017-5612, US

(21) Appl. No.: 10/481,866

(22) PCT Filed: Jun. 19, 2002
(86) PCT No.: PCT/KR02/01161

(30) Foreign Application Priority Data
Jun. 19, 2001 (KR) 2001/34694

(51) Int. Cl. H01M 8/10; C08J 5/22

(52) U.S. Cl. 429/33; 521/27

(57) ABSTRACT

Disclosed is a composite electrolyte membrane for fuel cells, comprising, based on weight of the membrane, a matrix blend resin that consists of 10-70 wt % of an ion exchange resin having a cation exchanging group on the side chain thereof, 10-70% wt of a non-conductive polymer and 10-70 wt % of a thermo-curable oligomer, and 10-60 wt % of a proton conductive material. In the matrix blend resin, the thermo-curable oligomer is cross-linked with chains of the non-conductive polymer and the ion exchange resin by heat, thus forming network structure, in which the proton conductive material of fine powder forms is uniformly dispersed. The above membrane is excellent in proton conductivity, mechanical properties, dimensional stability, and separability between gaseous or liquid fuel and gaseous oxidant. In particular, the membrance has excellent ion conductivity at high temperatures of 100° C. or more because of a moisturizing function of the proton conductive material.

### TECHNICAL FIELD

The present invention pertains to a composite electrolyte membrane useful in fuel cells operated at elevated temperature. More specifically, the present invention is directed to a polymer electrolyte membrane having excellent dimensional stability, mechanical properties and reactant separability at limited thickness, characterized in that nano-sized solid proton conductive filler particles are uniformly dispersed in a miscible polymer blend matrix composed of cation exchange polymer, non-conductive polymer and thermally cured polymer components.

### PRIOR ART

In recent years, ion exchange polymer membranes have been widely employed as a solid electrolyte in polymer electrolyte membrane fuel cells (PEMFC).

In general, the PEMFC are composed of a polymer electrolyte membrane, a catalytic electrode and a bipolar plate for fuel cell stacks. In most PEMFC, electrode layers of a cathode and an anode, each of which comprises polymeric binder and catalytically active powders such as platinum catalysts adsorbed to a carbon-based surface including carbon black, are bonded to the polymer electrolyte membrane by a variety of methods and the resultant structure is referred to as a membrane-electrode assembly (MEA).

The principle of generating electricity from the PEMFC is that, as shown in the following Reaction 1, a hydrogen molecule as a gaseous fuel is fed to the anode as a fuel electrode and adsorbed to platinum catalyst, generating protons and electrons by an oxidation reaction.

2H₂→4H⁺+4e⁻ Reaction 1

As such, the generated electrons reach the cathode as an oxidation electrode along an external circuit, and protons are transported to the cathode via the polymer electrolyte membrane. At the cathode, an oxygen molecule accepts the electrons transported to the cathode and is reduced to an oxygen ion, which reacts with proton to produce water, thus generating electricity, as seen in the following Reaction 2.

O₂+4e⁻→2O²⁻

2O²⁻+4H⁺→2H₂O Reaction 2

The electrolyte membrane for PEMFC is an insulation material that electrically separates the anode and the cathode, but works as a medium for transporting a proton from the anode to the cathode during cell operation. In addition, such a membrane is responsible for separation of reactive gas or liquid. In this respect, the electrolyte membrane should be excellent in electrochemical stability, low in Ohmic loss at high current density, and superior in separatability of reactants during cell operation. As well, for stack construction, mechanical properties and dimensional stability of a predetermined level or higher are required.

As the electrolyte membrane for PEMFC, research and development efforts had been carried out on polystyrene sulfonic acid based polymer resin in the early 1960s. However, since a drastic improvement in proton conductivity and electrochemical stability from perfluorosulfonic acid polymer resin (trade name: Nafion®) developed by E.I. Dupont de Nemours, Inc. in 1968 was reported, research into practical uses of PEMFC using Nafion® has been widely performed.

Nafion® resins are made of a non-crosslinked hydrophobic poly(tetrafluoro-ethylene) backbone with pendant side chains of perfluorinated vinyl ethers terminated by hydrophilic cation exchange group such as carboxylic and sulfonic acid. Meanwhile, the fluorine based cation exchange resins having a molecular structure similar to Nafion® have been developed by Asahi Chemical Industry, Asahi Glass KK and Tokuyama Soda Co.

Nafion-based cation exchange polymer membranes have various advantages over hydrocarbon-based polymers in terms of mechanical properties, high oxygen solubility by a poly (tetrafluoroethylene) main chain and high strain point of protons at hydrated state of the membrane. Moreover, the above membrane is much higher in electrochemical stability and durability than hydrocarbon based polymer membranes. The Nafion® membrane exhibits proton conductivity when it is hydrated to about 20% based on the polymer weight. So, the reactant gases used in PEMFC must be well saturated with distilled water to swell the electrolyte membrane. However, as water is gradually evaporated at temperatures higher than 100° C., the cell performances are drastically decreased due to the increased membrane resistance. Commonly, the Nafion® membrane having a thickness of about 50-175 μm is available on the market. In case of increasing thickness of the membrane, the dimensional stability and the mechanical properties are improved, while the conductance of the membrane is lowered. On the contrary, decreasing the thickness to reduce the membrane resistance results in lowered mechanical properties. As well, during cell operation, non-reactive hydrogen gas or liquid fuel (methanol) is passed through the polymer membrane and is oxidized on the cathode. Thus, cell performances are lowered due to decreased availability of reduction sites of oxygen. A hydrophilic cluster area in the Nafion® membrane is repeatedly swelled and shrunken by heating and hydration processes and maximum 15% thickness and volume changes are involved. In addition, the fluorine based resin including Nafion® is purchased at a high price of $800/m² or more, due to a limited production scale and a low yield. Accordingly, there is an urgent need for provision of an inexpensive electrolyte membrane for commercialization of PEMFC. Efforts to develop electrolyte membrane preparation techniques having improved mechanical properties, dimensional stability, reactant separability and economic benefit, with maintenance of proton conductivity at broader temperature ranges, have been vigorously carried out all over the world.

In this regard, U.S. Pat. Nos. 5,547,551, 5,599,614 and 5,635,041 disclose a method of preparing a reinforced composite membrane (trade name: Gore-Select™) by impregnating a liquid phase of cation exchange polymer resin into an expanded porous poly(tetrafluoroethylene) polymer membrane (U.S. Pat. Nos. 3,953,566 and 3,962,153).

Although such an electrolyte membrane has lower proton conductivity (unit: Ω⁻¹cm⁻¹) than the Nafion® membrane, its mechanical strength is maintained by the porous polymer support, and an about 25 μm thick composite membrane can be fabricated. Thus, the above composite polymer membrane has relatively higher conductance (unit: Ω⁻¹cm⁻¹) than the Nafion® membrane. In particular, ). In particular, a membrane-electrode assembly (trade name: PRIMEA®) using Gore-Select™ membrane exhibits the state-of-the art PEMFC performance around 80° C.

Also, in U.S. Pat. No. 6,130,175, there is disclosed a composite membrane consisting essentially of an ion exchange polymer resin having perfluorinated carboxylic functionality of methyl ester precursor form, impregnated as a first ion exchange material on one side of a porous poly(tetrafluoroethylene) film, and on the opposing side an ion exchange polymer resin having perfluorinated sulfonic functionality, impregnated as a second ion exchange material, in which each of said first and second ion exchange materials fills or occludes the pores at least near the surface of the one side and the opposing side of said film, whereby ionic conductivity and mechanical properties can be improved. In U.S. Pat. No. 6,042,958, there is disclosed a method of attaching non-woven glass fiber substrates to both sides of a porous poly(tetrafluoroethylene) film, followed by impregnating a perfluorinated sulfonic acid based polymer.

While the above-mentioned methods are capable of decreasing thickness of the composite polymer electrolyte membrane to about 25 μm for improvement of conductance, the tear strength of the resultant membrane becomes relatively low. Further, the above patents suffer from the disadvantages of high preparation cost due to impregnation of Nafion® to an expensive porous poly(tetrafluoroethylene) support having a void ratio of about 80%, and slow and discontinuous preparation process because the ion exchange resin is repeatedly impregnated onto the poly(tetrafluoroethylene) film having poor wettability. In particular, since such a membrane shows poor separability of liquid methanol in case of being formed into thin film, fuel loss is very large and catalytic efficiency is decreased upon application to direct methanol fuel cells (DMFC) injecting methanol directly to a fuel electrode, thus cell performances are lowered drastically.

Meanwhile, hydrogen gas reformed from various fuels, such as natural gas, gasoline, methanol, etc., contains a small amount of carbon monoxide (CO) gas which poison s the platinum anode catalysts. Carbon monoxide of ppm or more is adsorbed to the surface of platinum catalyst and functions to hinder oxidation of hydrogen fuels, thus remarkably lowering the fuel cell performance. Therefore, there have been tried various methods for prevention of catalyst poisoning by carbon monoxide in gaseous fuels. For instance, WO/69008 discloses various metal alloy catalysts resistant to carbon monoxide. There are proposed methods for preventing decrease of platinum catalytic activity in which the exothermic adsorption reaction of carbon monoxide is suppressed by increasing the operation temperature of the fuel cell to 120° C. or higher. In addition to increasing CO tolerance in the anode, high temperature operation of PEMFC can improve thermal management and heat utilization of the fuel cell stack, increase reaction rate at the anode and the cathode, and also potentially simplify fuel cell water management. In consideration of the above results, novel electrolyte membranes exhibiting excellent proton conductivity at high temperatures are of considerable interest.

In U.S. Pat. No. 5,525,436, there is disclosed an electrolyte membrane obtained by evaporating a solvent in a polybenzimidazole solution, to form a film, and doping the film with a strong acid, such as sulfuric acid, followed by drying it. In addition, U.S. Pat. Nos. 5,091,087, 5,599,639 and 6,187,231 disclose a method of preparing an electrolyte membrane by coating polyimide to polybenzimidazole, to prepare a composite film by compression molding, extracting polyimide with a solvent such as dichloromethane to form a porous polybenzimidazole film and doping the film with a strong acid, or by solidifying the polybenzimidazole solution doped with strong acid in a bath of a non-solvent or a mixture of non-solvent and solvent.

Additionally, the electrolyte membrane manufactured by sulfonating a certain polymer, such as polyphosphogen (WO 00/77874), polyethersulfone (Japanese Patent Laid-open Nos. Hei. 11-116679 and 11-67224), polyether-etherketone and poly(4-phenoxybenzoyl-1,4-phenylene), and then adding an organic or inorganic ion conductive material to the sulfonated polymer has been under study. But, variously required performances cannot be satisfied with such a single polymer resin. Recently, the proton conductive polymer is thus blended with a non-conductive polymer having excellent mechanical properties and reactant separability. Particularly, poly(vinylidene fluoride) (PVdF) is known as a polymer resin having partial miscibility with the cation exchange resin, and binary blend characteristics of Nafion®/PVdF under various film preparation conditions have been investigated [F. A. Landis and R. B. Moore, Macromolecules, 33, 603 (2000)], and there have been attempts to apply such a component to PEMFC [J. G. Lin, M. Ouyang, J. M. Fenton, H. R. Kunz, J. T. Koberstein and M. B. Cutlip, J. Appl. Polym. Sci., 70, 121 (1998)]. U.S. Pat. No. 6,103,414 discloses a technique of preparing a binary blend electrolyte membrane of a sulfonated polyphenylene oxide and a PVF resin.

As described above, several approaches have been attempted to prevent the loss of water from polymer electrolyte membranes thereby maintaining their proton conductivity at high temperatures near and above the normal boiling point of water. Hydrophilic, inorganic material may be incorporated into the perfluoirnated ionomer membrane to increase the binding energy of water. Ion or bipole of heteropolyacid compounds, such as phosphotungstic acid (PTA), is strongly bonded with proton and water evaporation at high temperatures is inhibited [S. Malhotra and R. Datta, J. Electrochem. Soc., 144, L23 (1997)]. However, water-soluble PTA may be leached out of the cell by mass transport of the water during cell operation. Thereafter, there are developed methods of replacing water, acting as a proton acceptor in the electrolyte membrane, with an organic solvent having low volatility. Water, as a Bronsted base, has a high dielectric constant and easily dissociates —SO₃H. Also, water is a by-product of the fuel cell reaction, and is understood as an essential element for use in the cation exchange membrane. Nowadays, electrolyte membranes containing components such as phosphoric acid, imidazole, butyl methyl imidazolium triflate and butyl methyl imidazolium tetrafluoroborate, have been under development [1: R. Savinell, et al., J. Electrochem. Soc., 141, L46 (1994); 2: K. D. Kreuer, A. Fuchs, M. Ise and M. Sapeth, J. Mater. Electrochim. Acta, 43, 1281 (1998)]. Furthermore, methods of using water-insoluble solid proton conductive material as an additive, capable of transporting a proton in the absence of water, have been tried. At present, a composite electrolyte membrane containing additives such as cesium hydrogen sulfate and zirconium hydrogen phosphate added to a cation exchange resin, is under vigorous study in the United States and Japan [S. M. Haile, D. A. Yoysen, C. R. I. Chisolm and R. B. Merle, Nature, 410, 910 (2001)], but mechanical properties, dimensional stability and fuel separability in the thin composite film are not yet improved.

### DISCLOSURE OF THE INVENTION

Leading to the present invention, the intensive and thorough research on composite electrolyte membranes, carried out by the present inventors aiming to avoid the problems encountered in the conventional expensive cation exchange membrane or the reinforced composite membranes manufactured by impregnation of cation exchange resin into porous poly(tetrafluoroethylene), resulted in the finding that proton conductive filler of powder form can be dispersed in a miscible matrix blend resin composed of proton conductive polymer having excellent proton conductivity, non-conductive polymer having superior mechanical properties and thermally cured oligomer, whereby a membrane having excellent proton conductivity at high temperature region, superior mechanical properties and reactant separability can be obtained at a low preparation cost.

Therefore, it is an object of the present invention to provide a composite polymer electrolyte membrane having excellent dimensional stability and mechanical properties, while decreasing an amount of expensive cation exchange resin and a thickness of the membrane.

It is another object of the present invention to provide a composite polymer electrolyte membrane which shows excellent proton conductivity at high temperatures of 100° C. or higher.

It is a further object of the present invention to provide a composite polymer electrolyte membrane acting as a superior barrier to gaseous (or liquid) fuels and gaseous oxidants even at a thin film of 50 μm or less thickness.

It is a further object of the present invention to provide a method of manufacturing such a composite electrolyte membrane having superior mass production characteristics through simplicity of manufacturing process.

It is a still further object of the present invention to provide a fuel cell comprising such a composite polymer electrolyte membrane.

In accordance with the first aspect of the present invention, there is provided a composite electrolyte membrane comprising a matrix blend resins consisting essentially of 10-70 wt % of ion exchange resin having cation exchanging groups on the side chains thereof, 10-70 wt % of non-conductive polymer and 10-70 wt % of thermally curable oligomer, and 10-60 wt % of solid proton conductive filler of powder form, based on the weight of the membrane, wherein a cross-linked polymer network is randomly entangled with chains of the non-conductive polymer and the ion exchange resin by the thermally curable oligomer to form a miscible blend, and particles of the proton conductive filler are uniformly dispersed in the matrix blend resins.

In accordance with the second aspect of the present invention, there is provided a method of manufacturing a composite polymer electrolyte membrane, comprising the steps of:

(a) separately dissolving each of ion exchange resin having cation exchanging groups on the side chains thereof and non-conductive polymer resin in organic solvent, followed by mixing the solutions together to prepare a first mixture;

(b) simultaneously or sequentially adding each of proton conductive filler of powder form and thermally curable oligomer to the first mixture to prepare a second mixture; and

(c) molding the second mixture into a molded body of film form, followed by heating the molded body of film form to evaporate the organic solvent contained therein and concurrently to perform cross-linking reaction of thermally curable oligomer.

In accordance with the third aspect of the present invention, there is provided a method of manufacturing a composite polymer electrolyte membrane, comprising the steps of:

(a) separately dissolving each of ion exchange resin having cation exchanging groups on the side chains thereof and non-conductive polymer resin in an organic solvent, followed by mixing the solutions together to prepare a first mixture;

(b) mixing the first mixture with thermally curable oligomer to prepare a second mixture;

(c) molding the second mixture into a molded body of film form, followed by heating the molded body of film form to evaporate the organic solvent contained therein and concurrently to perform cross-linking reaction by the thermally curable oligomer; and

(d) uniformly dispersing proton conductive filler of powder form in the molded body of film form via in-situ doping treatment.

### BRIEF DESCRIPTION OF THE DRAWINGS

The above and other objects, features and other advantages of the present invention will be more clearly understood from the following detailed description taken in conjunction with the accompanying drawings, in which:

FIGS. 1a to 1d are optical micrographs showing the membrane surface of each of PVdF, Example 1, and Comparative Examples 1 and 2;

FIG. 2 is a graph showing conductance at different temperatures of the membrane prepared by each of Example 5, and Comparative Examples 2 and 3;

FIG. 3 is a graph showing stress-strain curves of the membrane prepared by each of Example 1, and Comparative Examples 1 and 2;

FIG. 4 is a graph showing voltage-current density curves of the membrane prepared by each of Example 1, and Comparative Examples 1 and 3;

FIG. 5 is a graph showing polarization curves of 25 cm² PEMFC unit cell using the membrane prepared by Comparative Example 1;

FIG. 6 is a graph showing polarization curves of 25 cm² PEMFC unit cell using the membrane prepared by Comparative Example 3; and

FIG. 7 is a graph showing polarization curves of 25 cm² PEMFC unit cell using the membrane prepared by Example 5.

### BEST MODES FOR CARRYING OUT THE INVENTION

As for a commercially available reinforced composite ion-exchange polymeric membrane, an ion exchange resin solution is impregnated to a porous poly(tetrafluoroethylene) support and dried. Such a procedure is repeated and pores of the support are filled or occluded, to give the reinforced composite membrane. In contrast, the composite polymer electrolyte membrane of the present invention is cast in the film form on the surface of a glass or Teflon in such a manner that a proton conductive filler of powder (having nano-sized particle) form is uniformly dispersed in a miscible polymer matrix resins. As such, the matrix blend resins consist essentially of ion exchange resin, non-conductive polymer and thermally curable oligomer. The present invention is advantageous in that excellent conductivity can be obtained even with a decreased amount of expensive ion exchange resin due to good miscibility of polymer components, thus lowering the cost of the electrolyte membrane materials. In addition, since the membrane is obtained by evaporating a solvent in the polymer blend solution, a manufacturing process thereof is very simple and can be continuously performed, thus being suitable for mass production and manufacturing large sizes of the electrolyte membrane. Attributable to miscibility of polymer components, the composite polymer membrane can exhibit excellent mechanical properties and dimensional stability even at a thickness of 50 μm or less. Further, the composite membrane is a superior barrier to gaseous or liquid fuels and gaseous oxidants. In particular, the addition of hydrophilic proton conductive filler results in suppression of water evaporation at a high temperature. Thus, high temperature operation of PEMFC can be carried out, and catalyst poisoning of an anode can be reduced and efficiencies of a total system can be improved.

As the first component useful in the present invention, the ion exchange resin has cation exchanging groups, such as sulfonic acid, carboxylic acid, phosphoric acid, phosphonic acid and derivatives thereof, on the side chains thereof, and also can control proton conductivity depending on equivalent weight. In the present invention, it is preferred that the ion exchange resin has an ion exchange ratio of about 3-33, which corresponds to about 700-2000 equivalent weights (EW).

For the purpose of this application, equivalent weight is defined to be the weight of the polymer in sulfonic acid form required to neutralize one equivalent of NaOH. If the equivalent weight is excessively high, electric resistance is increased to that extent. But if such an equivalent weight is too small, mechanical properties become poor. Therefore, it is preferred that the equivalent weight is adjusted in a suitable range.

Examples of the ion exchange resin include Nafion® available from E. I. Dupont de Nemours, Flemion® available from Asahi Glass KK, and Aciplex® available from Asahi Chemical Industry (U.S. Pat. Nos. 3,282,875; 4,329,435; 4,330,654; 4,358,545; 4,417,969; 4,610,762; 4,433,082; and 5,094,995). In addition, the ion exchange resin disclosed in U.S. Pat. No. 5,596,676 of Imperial Chemical Industries PLC and U.S. Pat. No. 4,940,525 of Dow Chemical Co. can be used.

In this regard, the most widely used Nafion® resin has a structure based on (CF)₁₈₋₂₈SO₃H as represented by the following formula 1:

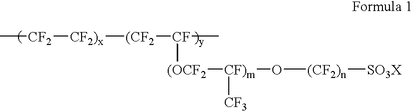

wherein, X represents H, Li, Na, K or NR¹R²R³R⁴, in which R¹, R², R³ and R⁴ represent independently H, CH₃ or C₂H₅; m is 1 or more, n is 2, x is 5-13.5 and y is 1,000 or more.

Nafion® has a micelle type structure upon hydrolysis of sulfonic acid on the chain termini. Such a structure provides a path for proton transfer and shows a behavior like a typical aqueous acid. In the present invention, the ion exchange resin can be used alone or in combinations thereof. The ion exchange resin is added in the amount of about 10-70 wt %, preferably 15-60 wt %, and most preferably 20-50 wt %, on the basis of the weight of the composite polymer membrane, to suit a required purpose. As for the composite electrolyte membrane according to the present invention, too small a resin content leads to drastically decreased miscibility of the polymer resins and low ionic conductivity. Meanwhile, if the content of the ion exchange resin is too large, separability of gaseous (or liquid) fuel in the prepared composite membrane is lowered and economic benefit is not realized.

As the second component useful in the present invention, the non-conductive polymer is excellent in miscibility with the ion exchange resin, and thus used as one component of the matrix blend resins. Also, this component has rubber-like properties in solid phase. . Such a non-conductive polymer is exemplified by poly(vinylfluoride) (PVF)-, poly(vinylidene fluoride) (PVdF)-, poly(ethyleneoxide) (PEO)-, poly(benzimidazole) (PBI)-based polymers or combinations thereof. Preferably, this non-conductive polymer has a number average molecular weight of about 10000 or more, and is used in the amount of about 10-70 wt %, and preferably of about 15-60 wt %, on the basis of the weight of the composite membrane, according to use. Most preferably, about 20-50 wt % of the non-conductive polymer is used to obtain a complete miscibility. When the amount of the non-conductive polymer is too small, separability of reactants for fuel cells in the thin film form is decreased. Meanwhile, when the amount is too large, ionic conductivity of the composite polymer membrane can be lowered.

Among the non-conductive polymers, poly(vinylidene fluoride) (PVdF) based polymer is preferably used, and most preferably, homopolymers, copolymers or combinations thereof, of Kynar® available from Elf Atochem Co., can be used. In order to improve hydrophilicity of the composite electrolyte membrane, the non-conductive polymer may be employed with being optionally sulfonated.

As the third component useful in the present invention, the thermally curable oligomer has one unsaturated functional group on each of both termini of the chain, and is exemplified by poly(ethyleneglycol diacrylate) (PEGDA) represented by the following Formula 2 having 3-14 ethylene oxide groups (—CH₂CH₂O—) in the oligomer, poly(ethyleneglycol dimethacrylate) (PEGDMA) represented by the following Formula 3 or combinations thereof. In the case of requiring flexibility of the composite electrolyte membrane, it is preferred that an oligomer having 9 or more ethylene oxide groups (MW 500 or more) is used. When excellent strength is necessary, an oligomer having molecular weight less than 500 is favorably used.

CH₂═CHCOO(CH₂CH₂O)ₚCOCH═CH₂ Formula 2

Wherein, p represents 3-14

CH₂═C(CH₃)COO(CH₂CH₂O)_{q}COC(CH₃)═CH₂ Formula 3

Wherein, q represents 3-14

The above component is cross-linked by heat, to form a network structure and randomly entangled with chains of the ion exchange resin and the non-conductive polymer. Thereby, dimensional stability of the composite polymer electrolyte membrane can be effectively improved, and passage of the reactants is restricted. The thermally curable oligomer is used in the amount of about 10-70 wt %, preferably about 15-60 wt %, and most preferably about 20-50 wt % for complete miscibility, based on the weight of the composite membrane, to suit a required purpose. If the amount of the thermally curable oligomer is too small, dilution effect of the oligomer decreases a cross-linking density, thereby not forming the network structure, thus not maintaining dimensional stability in the thin film. On the other hand, if the amount is too large, ionic conductivity of the membrane is reduced.

As the fourth component in the present invention, the proton conductive filler is a hydrophilic inorganic ion conductive material of powder form, and present in the membrane to prevent a decrease of proton conductivity due to water evaporation upon operation of the composite membrane at 100° C. or higher. Specifically, the above component is dispersed in the powder form having diameter of about 10-500 nm within the matrix blend resins, thereby enhancing a water-retaining site or a transfer site of protons.

The proton conductive filler is exemplified by:

phosphotungstic acid (PTA);

silicotungstic acid;

zirconium hydrogen phosphate (ZHP);

α-Zr(O₃PCH₂OH)_{1.27}(O₃PC₆H₄SO₃H)_{0.73}.nH₂O;

ν-Zr(PO₄)(H₂PO₄)_{0.54}(HO₃PC₆H₄SO₃H)_{0.46}.nH₂O;

Zr(O₃PC₂H₅)_{1.15}Y_{0.85};

Zr(O₃PCH₂OH)_{1.27}Y_{0.73}.nH₂O;

α-Zr(O₃PC₆H₄SO₃H).3.6H₂O;

α-Zr(O₃POH).H₂O;

(P₂O₅)₄(ZrO₂)₃ glass;

P₂O₅—ZrO₂—SiO₂ glass;

CsDSO₄;

β-Cs₃(HSO₄)₂(H_{N}(P, S)O₄);

α-Cs₃(HSO₄)₂(H₂PO₄);

CsHSO_{4;}

Ba₂YSnO_{5.5};

SnO₂.2H₂O;

Sb₂O₅.5.4H₂O;

H₂Ti₄O₉.1.2H₂O;

HUO₂AsO₄.4H₂O;

HUO₂PO₄.4H₂O;

H₃Sb₃P₂O₁₄ .10H₂O;

HSbP₂O₈.nH₂O;

H₂Sb₄O₁₁.3H₂O; and

HSbO₃.2H₂O.

This component can be used alone or in combinations thereof. Preferably, zirconium hydrogen phosphate is used.

However, phosphotungstic acid and silicotungstic acid are water-soluble, and can be leached from membrane since the liquid water by-products are drained from PEMFC over time. So, the above fillers are used with being deposited on the support, for example, silica (fumed silica, Aerosil®, Cab-o-sil, etc.), clay (montmorillonite, saponite, hectorite, laponite, tetrasilicic mica), alumina, mica or zeolite (trade name: SAPO-5, XSM-5, AIPO-5, VPI-5 and MCM-41 etc.), according to well-known methods in the art. As such, use of the support is expected to result in improvement of mechanical properties. It should be noted that, the water-insoluble proton conductive filler can be used alone except some cases as above, but can be optionally used in the form of being deposited on the above-mentioned support in order to improve mechanical properties.

According to the present invention, the proton conductive filler is used in the amount of about 10-60 wt %, preferably about 10-55 wt %, and most preferably about 10-40 wt %, based on the weight of the composite membrane. Such an amount can be varied in the above range for various purposes. When the amount of the proton conductive filler is too small, proton conductivity is drastically decreased upon operation of the membrane at high temperatures of 100° C. or more. Meanwhile, if the amount is excessively large, the composite membrane becomes brittle, thus rather decreasing mechanical properties. When introduced into the membrane in the form of being deposited on the support, the proton conductive material is used in the amount of about 5-50 wt % based on the support.

The composite polymer electrolyte membrane of the present invention has advantages in light of simple manufacturing process and adaptability to mass production, because the membrane is manufactured by preparation of the polymer mixed solution and evaporation of the solvent.

A description will be given of an embodiment of the manufacturing method of the composite polymer electrolyte membrane, below.

The ion exchange resin having the cation exchanging groups on the side chains thereof is dissolved in an organic solvent to prepare an ion exchange resin solution. In general, the ion exchange resin is commercially available in the form of being dissolved in water and alcohol, for example, water/2-propanol. Accordingly, water and alcohol are evaporated therefrom, and then the resin is dissolved at the concentration of about 0.5-30 wt % in the organic solvent to obtain an ion exchange resin solution. Separately, the non-conductive polymer is dissolved at the concentration of about 0.5-30 wt % in the organic solvent to give the non-conductive polymer solution. The ion exchange resin solution is mixed with the non-conductive polymer solution at about 25-200° C., preferably at about 50-150° C. for 24 hours with mechanical stirring, to give a polymer blend solution. At this time, the organic solvent is required to have excellent solubility for both of the ion exchange resin and the non-conductive polymer, and is not limited to a specific solvent. The suitable organic solvent includes 2-propanol (IPA), N-methyl-2-pyrrolidinone (NMP), dimethyl formamide (DMF), dimethyl acetamide (DMA), tetrahydrofuran (THF), dimethyl sulfoxide (DMSO), acetone, methyl ethyl ketone (MEK), tetramethylurea, trimethyl phosphate, butyrolactone, isophorone, carbitol acetate, methyl isobutyl ketone, N-butyl acetate, cyclohexanone, diacetone alcohol, diisobutyl ketone, ethyl acetoacetate, glycol ether, propylene carbonate, ethylene carbonate, dimethylcarbonate, diethylcarbonate or combinations thereof.

Next, each of the proton conductive material and the thermally curable oligomer is simultaneously or sequentially added to the above polymer blend solution and mixed. Such a mixing step is preferably performed at about 30-50° C. for about 2 hours or more with vigorous stirring. In particular, it is preferred that the proton conductive material dispersed in 2-propanol solvent is introduced to the solution. As such, to provide uniform proton conductivity to the whole polymer electrolyte membrane, it is preferred that the proton conductive filler is made uniform in its size through ball milling, and then added. Meanwhile, with a view to easy cross-linking reaction by the thermally curable oligomer at the subsequent step, an initiator may be added in the amount of about 0.1-5.0 wt % based on the weight of the thermally curable oligomer. After addition of the initiator, the mixing is preferably conducted with stirring for about 5 minutes-1 hour. Examples of such an initiator include alkyl peroxides, such as benzoyl peroxide, and di-t-butylperoxide; cumene hydro-peroxide; peresters, such as t-butylperbenzoate; or azo compounds.

Thereafter, the thus obtained mixture is molded to film form having a predetermined thickness via known extrusion molding, injection molding, doctor blade coating, thin-film casting, etc., and heated at about 50-150° C. (for about 30 minutes-24 hours). As such, the organic solvent contained in the molded body of film form is evaporated and concurrently the cross-linking reaction by the thermally curable oligomer is performed.

In order to further increase the ionic conductivity of the prepared composite polymer electrolyte membrane, the above method may further comprise the step of sulfonating the non-conductive polymer, in which the prepared composite polymer electrolyte membrane is treated with basic components, such as KOH, NaOH, lithium 2,2,6,6-tetramethylpiperidide, tetramethylammonium hydroxide, potassium t-butoxide, and subjected to dehydrofluorination and treated with sulfuric acid. Alternatively, before forming the composite polymer electrolyte membrane, the non-conductive polymer may be treated with the basic component and sulfuric acid to sulfonate, followed by dissolving the sulfonated polymer in the organic solvent and mixed with the ion exchange resin solution. In addition, the sulfonation of the non-conductive polymer may be conducted in the manner that non-conductive polymer solution is added with the basic component and mixed with the ion exchange resin solution, followed by forming the composite polymer electrolyte membrane according to the above-mentioned procedure, and then treated with sulfuric acid.

Another embodiment of the composite membrane preparation method is as follows:

Without introduction of the proton conductive material, the ion exchange resin solution and the non-conductive polymer solution are first mixed and then added with the thermally curable oligomer. Thusly obtained tertiary component blend solution is heated to evaporate the solvent and to perform the cross-linking reaction. Such a procedure is carried out under almost the same conditions as in the above mixing, film formation and curing conditions, except that the proton conductive material is not introduced.

Such a molded body of film form is doped with the proton conductive filler, whereby the proton conductive filler of powder form is uniformly dispersed in the blend resins. In this regard, use of zirconium hydrogen phosphate as an ion conductive material is disclosed in U.S. Pat. No. 5,919,583, in which the molded body of film form is swelled, added with zirconyl chloride and treated with phosphoric acid. Accordingly, zirconium hydrogen phosphate is formed in the matrix blend resin and uniformly dispersed.

Optionally, the above method further comprises the step of sulfonating the non-conductive polymer, before or after the above doping step. Such a procedure also includes the film formation using the basic component-added non-conductive polymer solution as aforementioned, doping treatment and sulfuric acid treatment.

The composite polymer electrolyte membrane of the present invention is suitable for use in PEMFC. More specifically, the composite membrane exhibits superior mechanical properties and at least equal conductance even at thinner thickness, to those of the conventional Nafion® membrane. The used amount of the ion exchange resin is decreased, whereby the production cost of a fuel cell can be drastically reduced and fuel gas or liquid can be effectively separated. Excellent dimensional stability leads to superior handlability. Hence, the thickness of the inventive membrane can be adjusted in the range of 10-250 μm.

The fuel cell configuration is well known in the art. The fuel cell may be configured to have a unit cell structure or PEMFC stack. For instance, a laminated structure comprising current collector/anode/composite polymer electrolyte membrane/cathode/current collector/anode/composite polymer electrolyte membrane/cathode/current collector, in order, may be contained in the cell, together with terminals connected to the anodes and the cathodes to feed fuels and oxidants thereto, and a cell case sealing around the above laminated structure.

A better understanding of the present invention may be obtained in light of the following examples which are set forth to illustrate, but are not to be construed to limit the present invention.

### EXAMPLE 1

While 100 g of 5 wt % commercially available Nafion®/H₂O/2-propanol (Solution Technology Inc., EW=1,100) solution was stirred at room temperature for 48 hours, the solvent was evaporated off to give about 5 g of Nafion® gel, which was then added with 95 g of dimethylacetamide (DMA), yielding about 5 wt % Nafion®/DMA solution. Such a solution was preheated in a water bath at 60° C. for 24 hours to evaporate off the remaining moisture. Separately, 5 g of PVDF (Elf Atochem America, Inc., Kynar Flex® 761) was dissolved in 95 g of DMA to prepare 5 wt % PVdF/DMA solution, after which 20 g of the above solution was mixed with 50 g of 5 wt % Nafion®/DMA solution. 5 g of zirconium hydrogen phosphate (ZHP) was added to 95 g of 2-propanol (IPA) and stirred at room temperature for 48 hours, and further at 50° C. for 48 hours using a jar mill (trade name: Two Tier Mills, Cole-Parmer Co.) with a zirconia ball of 10 mm diameter. Thereby, zirconium hydrogen phosphate of about 100 nm in size was uniformly dispersed in the solution. 10 g of thusly obtained ZHP/IPA mixture was added to the Nafion®/PVdF/DMA solution.

Such a mixture was added with 1 g of poly(ethyleneglycol diacrylate) (PEGDA: Aldrich, MW=742) and vigorously stirred at 50° C. for 10 minutes, to which 0.03 g of benzoyl peroxide was added. The reaction mixture was vigorously stirred for 10 minutes, and applied to the surface of poly(tetrafluoroethylene) layer by use of a doctor blade. This film was heated in an oven maintained at about 100° C. for 12 hours, to prepare a 30 μm thick composite polymer electrolyte membrane.

The proton conductivity of composite polymer membrane was measured by a current interruption method. While both ends of a test piece having a size of 1×5 cm² and a thickness of 30-50 μm were applied with a predetermined alternating current in a temperature and humidity controlled chamber, a difference of alternating potentials generated at the center of the test piece was monitored to determine proton conductivity of the teat piece. Mechanical properties of the prepared composite polymer membrane were examined according to ASTM-638 or ASTM-882. As such, machine parameters were as follows:

| | |
|---|---|
| Cross head speed: 25 cm/min, | Grip distance: 6.35 cm |
| Temperature: 25° C., | Humidity: 50% |

To both sides of the composite polymer membrane, a commercially available catalytic electrode layer was coated by hot-pressing process, to manufacture a membrane-electrode assembly. Before the hot-pressing process, 1 wt % Nafion®/H₂O/2-propanol solution was sprayed to both sides of the membrane and dried at room temperature, to form a Nafion® layer being about 5 μm thick for use in smooth assembly with the Nafion®-impregnated electrode. The electrode used for manufacture of MEA was the ELAT® electrode having a single-sided, available from E-TEK Inc., in which a support was a 0.36 mm thick plain weave carbon cloth and a final thickness of a catalyst-formed layer was approximately 0.45 mm, and a load of a catalytic metal was about 0.4 mg/cm². As such, Pt-Ru/C alloy catalyst was used for the anode and Pt/C catalyst was for the cathode. In order to smoothly conduct protons at the interface between electrolyte and catalyst, the ELAT® electrode was impregnated with about 0.7 mg/cm² ion exchange resin before the hot-pressing process, through a repeated procedure of brushing commercially available 5 wt % Nafion®/H₂O/2-propanol solution and drying of the brushed solution at 70° C. for 10 minutes. The hot-pressing condition was set to apply a pressure of about 80 kg/cm² at 140° C. for 5 minutes.

MEA was mounted to a 25 cm² single cell connected to a load (Scribner Series 890B Electronic Load). The single cell was compressed under 30 lb-in on each of 8 pair of bolts and nuts. Incompressible silicon-coated glass fiber (0.3 mm nominal thickness) gasket materials, placed on both sides of the membrane, provide sealing on bolting the cell components together. High purity hydrogen (H₂) and oxygen (O₂) were passed through a humidifier to be saturated with water, then used as a fuel and an oxidant, respectively. Cell performance was tested at 70-130° C. when a humidifying temperature was maintained to 80° C. for both of gaseous fuel and gaseous oxidant. A stoichiometric ratio of gas flux was set to 2.0 at the anode and 3.0 at the cathode under hydrogen and oxygen feeding pressure of 30/30 psig.

### EXAMPLE 2

While 100 g of 5 wt % commercially available Nafion®/H₂O/2-propanol (Solution Technology Inc., EW=1,100) solution was stirred at room temperature for 48 hours, the solvent was evaporated off to give about 5 g of Nafion® gel, which was then added with 95 g of dimethylacetamide (DMA), yielding about 5 wt % Nafion®/DMA solution. This solution was preheated in a water bath at 60° C. for 24 hours to evaporate off the remaining moisture. Separately, 30 g of PVdF (Elf Atochem America, Inc., Kynar Flex® 761) powder was dispersed in 200 g of 5 wt % KOH/methanol at 80° C., stirred for 1hour, filtered, washed with methanol and dried. The dried PVDF was stirred in 1 M aqueous sulfuric acid solution at 80° C. for 4 hours, filtered, washed with water and dried in a vacuum oven of 80° C. 5 g of PVDF powder, treated with base and strong acid, was dissolved in 95 g of DMA to prepare 5 wt % PVdF/DMA solution. Thereafter, 20 g of the above solution was mixed with 50 g of 5 wt % Nafion®/DMA solution.

5 g of zirconium hydrogen phosphate (ZHP) was added to 95 g of 2-propanol (IPA) and stirred at room temperature for 48 hours, and further at 50° C. for 48 hours using the jar mill with a zirconia ball of 10 mm diameter. Thereby, zirconium hydrogen phosphate of about 100 nm in size was uniformly dispersed in the solution. 20 g of thusly obtained ZHP/IPA mixture was added to the above Nafion®/PVdF/DMA solution.

To thusly obtained mixture, 1 g of polyethyleneglycol diacrylate (PEGDA: Aldrich, MW=742) was added, and such a mixed solution was vigorously stirred at 50° C. for 10 minutes, added with 0.03 g of benzoyl peroxide with vigorous stirring for 10 minutes, and applied to the surface of polytetrafluoroethylene layer using a doctor blade. Such a film was heated in an oven maintained at about 100 ° C. for 12 hours, to prepare a composite polymer electrolyte membrane 30 μm thick.

Physical properties and cell performance of the prepared membrane were assayed according to the same manner as in Example 1.

### EXAMPLE 3

100 g of 5 wt % commercially available Nafion®/H₂O/2-propanol (Solution Technology Inc., EW=1,100).solution was stirred at room temperature for 48 hours, and thus the solvent was evaporated off to prepare about 5 g of Nafion® gel, which was then added with 95 g of dimethylacetamide (DMA), yielding about 5 wt % Nafion®/DMA solution. This solution was preheated in a water bath at 60° C. for 24 hours to evaporate off the remaining moisture. Separately, 5 g of PVDF (Elf Atochem America, Inc., Kynar Flex®761) was dissolved in 85 g of DMA to obtain a PVdF/DMA solution, which was vigorously stirred at 60° C. for 3 hours while 2 g of potassium t-butoxide in 10 g of DMA was added dropwise thereto. 20 g of the above solution was mixed with 50 g of 5 wt % Nafion®/DMA solution.

5 g of zirconium hydrogen phosphate (ZHP) was added to 95 g of 2-propanol (IPA) and stirred at room temperature for 48 hours, and further at 50° C. for 48 hours using the jar mill with a zirconia ball of 10 mm diameter. Thereby, zirconium hydrogen phosphate of about 100 nm in size was uniformly dispersed in the solution. 30 g of thusly obtained ZHP/IPA mixture was added to the Nafion®/PVdF/DMA solution.

Such a mixed solution was added with 1 g of polyethyleneglycol diacrylate (PEGDA: Aldrich, MW=742) and vigorously stirred at 50° C. for 10 minutes. Then, the stirred solution was added with 0.03 g of benzoyl peroxide with vigorous stirring for 10 minutes, and applied to the glass surface by use of a doctor blade. Such a film was heated in an oven maintained at about 100° C. for 12 hours, to manufacture a composite polymer electrolyte membrane being 30 μm thick. The dried membrane was washed with distilled water and methanol, boiled in 1 M aqueous sulfuric acid solution at 100° C. for 12 hours, washed with distilled water cooled to room temperature, and dried.

Physical properties and cell performance of the prepared membrane were assayed according to the same manner as in Example 1.

### EXAMPLE 4

100 g of 5 wt % commercially available Nafion®/H₂O/2-propanol (Solution Technology Inc., EW=1,100) solution was stirred at room temperature for 48 hours and the solvent was evaporated off, preparing about 5 g of Nafion® gel, which was then added with 95 g of dimethylacetamide (DMA) to produce about 5 wt % Nafion®/DMA solution. Such a solution was preheated in a water bath at 60° C. for 24 hours to evaporate off the remaining moisture. Separately, 5 g of PVdF (Elf Atochem America, Inc., Kynar Flex®761) was dissolved in 95 g of DMA to prepare 5 wt % PVdF/DMA solution. 20 g of the above solution was mixed with 50 g of 5 wt % Nafion®/DMA solution.

5 g of zirconium hydrogen phosphate (ZHP) was added to 95 g of 2-propanol (IPA) and stirred at room temperature for 48 hours, and further at 50° C. for 48 hours using the jar mill with a zirconia ball of 10 mm diameter. Thereby, zirconium hydrogen phosphate of about 100 nm in size was uniformly dispersed in the solution. 20 g of thusly obtained ZHP/IPA mixture was added to the Nafion®/PVdF/DMA solution.

This mixture was added with 1 g of polyethyleneglycol diacrylate (PEGDA:

Aldrich, MW=742) and vigorously stirred at 50° C. for 10 minutes. Then, the stirred solution was added with 0.03 g of benzoyl peroxide, vigorously stirred for 10 minutes, and applied to the glass surface by use of a doctor blade. Such a film was heated in an oven maintained at about 100° C. for 12 hours, to prepare a 30 μm thick composite polymer electrolyte membrane. The composite electrolyte membrane was boiled in 5 wt % KOH/methanol aqueous solution at 80° C. for 3 hours and additionally in 1 M aqueous sulfuric acid solution at 100° C. for 12 hours, washed with distilled water cooled to room temperature, and dried. Physical properties and cell performance of the prepared membrane were assayed according to the same manner as in Example 1.

### EXAMPLE 5

100 g of 5 wt % commercially available Nafion®/H₂O/2-propanol (Solution Technology Inc., EW=1,100) solution was stirred at room temperature for 48 hours and the solvent was evaporated off, to give about 5 g of Nafion® gel, which was then added with 95 g of dimethylacetamide (DMA), producing about 5 wt % Nafion®/DMA solution. Such a solution was preheated in a water bath at 60° C. for 24 hours to evaporate off the remaining moisture. Separately, 5 g of PVdF (Elf Atochem America, Inc., Kynar Flex® 761) was dissolved in 95 g of DMA to prepare 5 wt % PVdF/DMA solution. 20 g of the above solution was mixed with 50 g of 5 wt % Nafion®/DMA solution. Thusly prepared polymer blend solution was added with 1 g of polyethyleneglycol diacrylate (PEGDA: Aldrich, MW=742) and vigorously stirred at 50° C. for 10 minutes. Then, the stirred solution was added with 0.03 g of benzoyl peroxide, vigorously stirred again for 10 minutes, and applied to the glass surface by use of a doctor blade. Such a film was heated in an oven maintained at about 100° C. for 12 hours, to prepare a composite polymer electrolyte membrane being 30 μm thick. The above membrane was boiled in 5 wt % KOH/methanol aqueous solution at 80° C. for 3 hours and additionally in 1 M aqueous sulfuric acid solution at 100° C. for 12 hours, washed with distilled water of room temperature and dried. Thus chemically modified electrolyte membrane was swelled in methanol/water (1/1 vol/vol) co-solvent at 50° C., and boiled in 3 M aqueous zirconium chloride hydrate (ZrOCl₂.nH₂O) solution at 80° C. for 3 hours. Then, the membrane surface was washed with deionized water at room temperature and boiled in 1 M aqueous phosphoric acid solution at 80° C. for 6 hours, thereby forming zirconium hydrogen phosphate in the electrolyte membrane. After phosphoric acid treatment, the unreacted components on the composite electrolyte membrane were washed away with deionized water and dried at room temperature. Physical properties and cell performance of the prepared membrane were assayed according to the same manner as in Example 1.

### COMPARATIVE EXAMPLE 1

Commercially available Nafion® 115 (EW=1 100, thickness: 130 μm) membrane, prepared by E.I. Dupont de Nemours, Inc., was treated with hydrogen peroxide at 100° C. for 3 hours, to remove contaminants on Nafion® membrane surface. The membrane was treated with 1 M aqueous sulfuric acid solution at 100° C. for 2 hours and stored in deionized water. Physical properties and cell performance of the prepared Nafion® membrane were assayed according to the same manner as in Example 1.

### COMPARATIVE EXAMPLE 2

5 g of PVdF (Elf Atochem America, Inc., Kynar Flex® 761) was dissolved in 95 g of DMA (dimethylacetamide) to prepare 5 wt % PVdF/DMA solution. 20 g of the above solution was mixed with 30 g of 5 wt % available Nafion®/H₂O/2-propanol (Solution Technology Inc., EW=1,100) with mechanical stirring at 100° C. for 48 hours, and applied to the glass surface using a doctor blade. About 30 Elm thick membrane was fabricated by heating in an oven maintained at 100° C. for 12 hours.

### COMPARATIVE EXAMPLE 3

To impregnate an ion conductive resin to pores of an expanded porous poly(tetrafluoroethylene) (trade name: Tetratex®, thickness 22 μm, porosity about 80%) supplied by Tetratec Co. Ltd., poly(tetrafluoroethylene) film was fixed to an embroidery frame and to its both sides, 5 wt % Nafion®/H₂O/2-propanol (Solution Technology, Inc., EW=1,100) solution was brushed and dried in an oven at 80° C. for 1 minute. Such a procedure was repeated 3 times or more, to occlude the pores of polytetrafluoroethylene film. The impregnated Nafion® was treated with deionized water at 100° C. for 3 hours for swelling thereof. Physical properties and cell performance of the prepared electrolyte membrane were assayed according to the same manner as in Example 1.

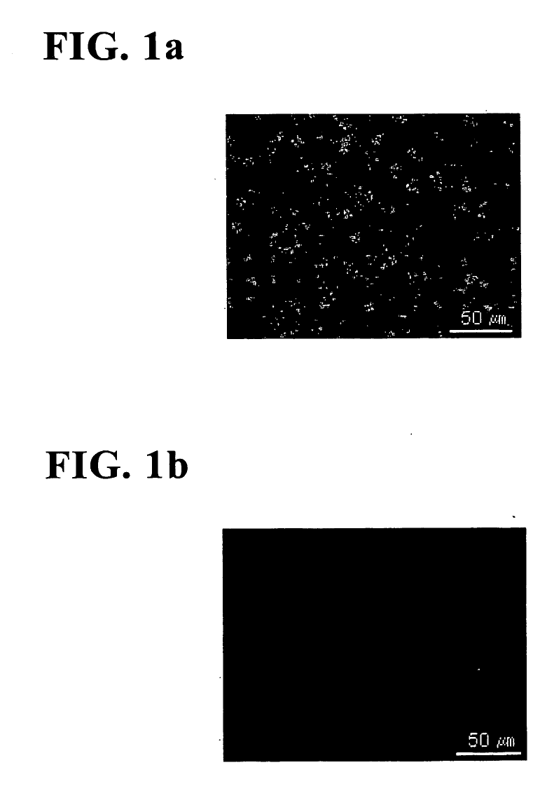

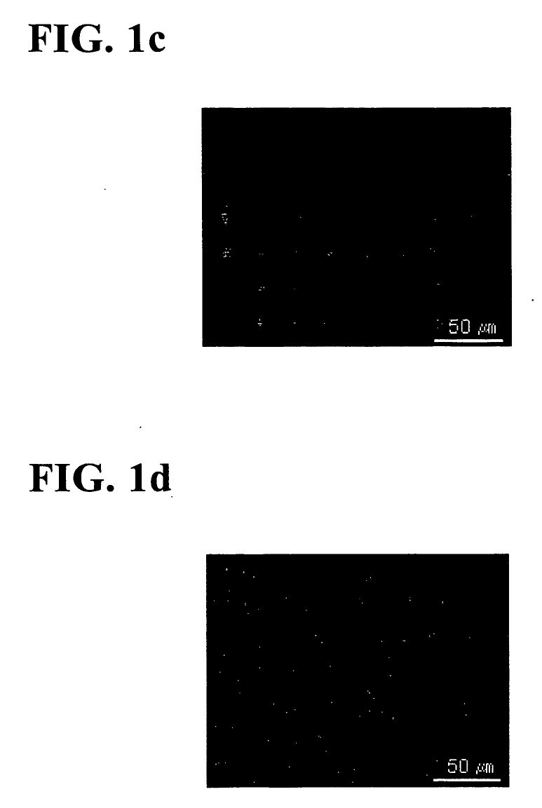

According to Examples and Comparative Examples, the composite polymer electrolyte membrane of the present invention did not generate phase-separation due to excellent miscibility, different from Comparative Example 2, as seen in FIG. 1. In addition, it was confirmed that the proton conductive filler was uniformly dispersed. In the case of Comparative Example 2, a simple mixing of the ion exchange resin, such as commercialized Nafion®, in an aqueous solution and the non-conductive polymer, resulted in decreased miscibility due to water repellence of the non-conductive polymer, thus causing phase-separation.

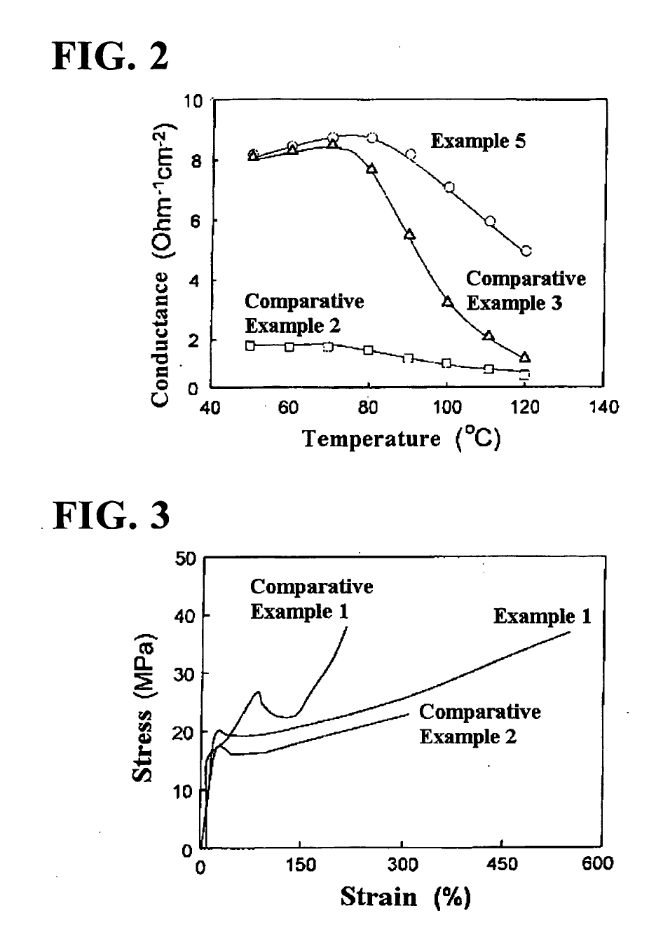

As shown in FIG. 2, by excellent miscibility and film formability, the conductance in Example 5 was superior to that of Comparative Examples 2 and 3. In particular, at high temperatures of 100° C. or more, the membrane of Example 5 had remarkably higher conductance, thus being applicable over a broader temperature range.

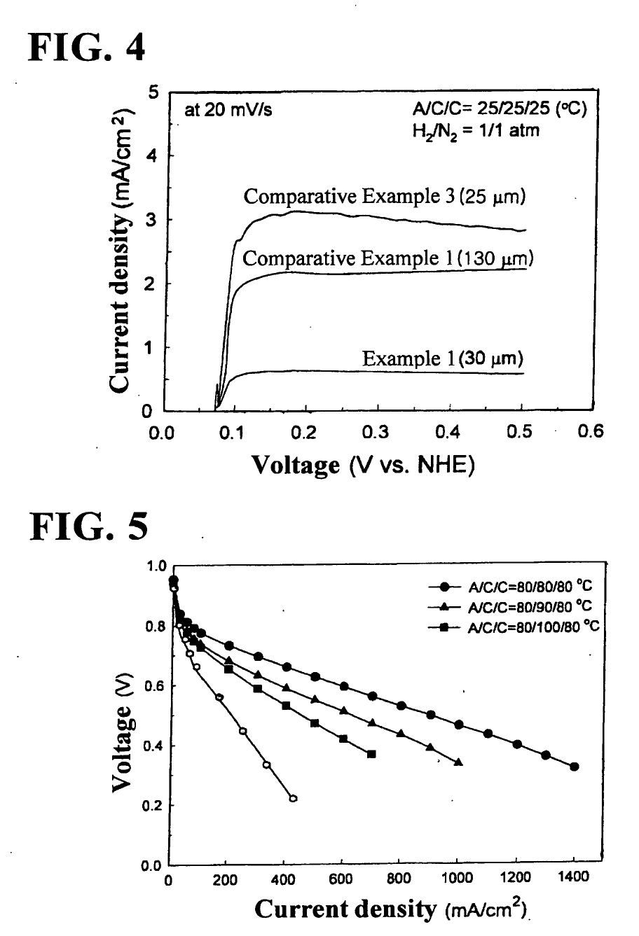

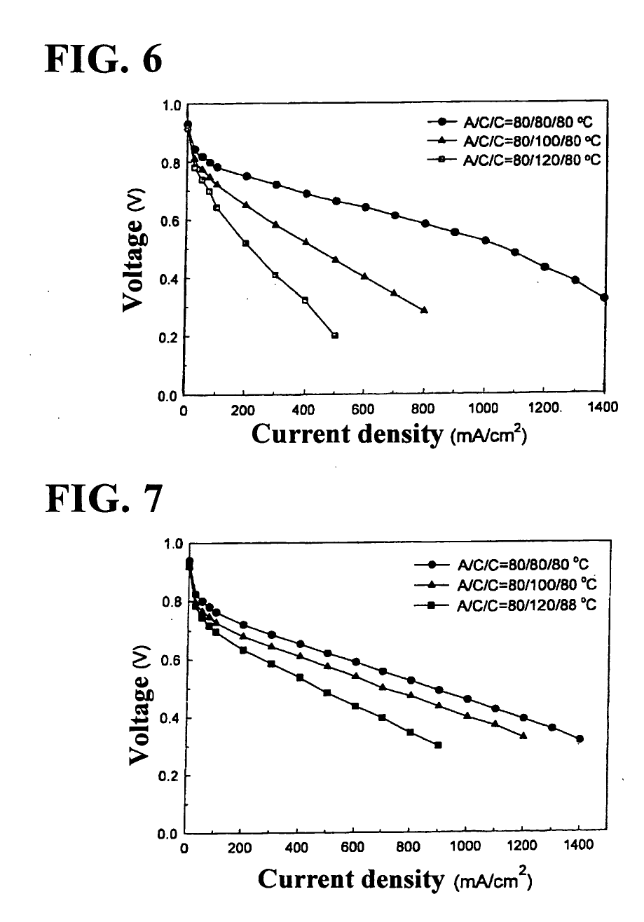

As in FIG. 3, the membrane prepared in accordance with Example 1 was superior in elongation ratio to Comparative Examples 1 and 2. In FIG. 4, even in thin film form, crossover current of the hydrogen fuel in Example 1 was ¼ that of Comparative Example 1, and separability of the thin film was excellent. In FIGS. 5 to 7, as for the performances of 25 cm² single cells according to kinds of electrolyte membrane, the membrane of Example 5 had performance equal to that of Comparative Example 1 or 3 at about 80° C., but was drastically increased at high temperatures of 100° C. or more.

### INDUSTRIAL APPLICABILITY

The composite polymer electrolyte membrane of the present invention is advantageous in light of excellent proton conductivity and mechanical properties, superior barrier characteristic to gaseous or liquid fuels and gaseous oxidants, excellent water-retaining effect and high temperature operation of fuel cells, while the used amount of expensive ion conductive polymer is decreased and the thickness of the membrane becomes thinner. After simple blending of a polymer solution, solvent evaporation leads to preparation of the membrane, whereby such a preparation process is simplified and the membrane can be fabricated on a large scale, thus economic benefit being realized.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

1. A composite electrolyte membrane for fuel cells, comprising a matrix blend resins consisting essentially of 10-70 wt % of ion exchange resin having cation exchanging groups on the side chains thereof, 10-70 wt % of non-conductive polymer and 10-70 wt % of thermally curable oligomer, and 10-60 wt % of proton conductive filler of powder form, based on the weight of the membrane, wherein cross-linked polymer network is randomly entangled with chains of the non-conductive polymer and the ion exchange resin by the thermally curable oligomer to form a miscible blend, and particles of the proton conductive filler are uniformly dispersed in the matrix blend resins.

2. The membrane as defined in claim 1, wherein the cation exchanging groups in the ion exchange resin are sulfonic acid, carboxylic acid, phosphoric acid, phosphonic acid or derivatives thereof.

3. The membrane as defined in claim 1, wherein the ion exchange resin is composed of a single ion exchange resin or a combination of at least two ion exchange resins.

4. The membrane as defined in claim 1, wherein an ion exchanging ratio of the ion exchange resin ranges from 3 to 33.

5. The membrane as defined in claim 1, wherein the non-conductive polymer in the membrane is sulfonated.

6. The membrane as defined in claim 1, wherein the thermally curable oligomer is selected from the group consisting of polyethyleneglycol diacrylate represented by the following formula 2, polyethyleneglycol dimethacrylate represented by the following formula 3, and a combination thereof:
CH₂═CHCOO(CH₂CH₂O)ₚCOCH═CH₂ Formula 2
Wherein, p represents 3-14
CH₂═C(CH₃)COO(CH₂CH₂O)_{q}COC(CH₃)═CH₂ Formula 3
Wherein, q represents 3-14

7. The membrane as defined in claim 1, wherein the proton conductive filler has a diameter of 10-500 nm.

8. The membrane as defined in claim 1, wherein the proton conductive filler is selected from the group consisting of:
phosphotungstic acid;
silicotungstic acid;
zirconium hydrogen phosphate;
60 -Zr(O₃PCH₂OH)_{1.27}(O₃PC₆H₄SO₃H)_{0.73}.nH₂O;
ν-Zr(PO₄)(H₂PO₄)_{0.54}(HO₃PC₆H₄SO₃H)_{0.46}.nH₂O;
Zr(O₃PC₂H₅)_{1.15}Y_{0.85};
Zr(O₃PCH₂OH)1.27Y_{0.73}.nH₂O;
α-Zr(O₃PC₆H₄SO₃H).3.6H₂O;
α-Zr(O₃POH).H₂O;
(P₂O₅)₄(ZrO₂)₃ glass;
P₂O₅—ZrO₂—SiO₂ glass;
CₛDSO₄
βCs₃(HSO₄)₂(H_{N}(P,S)O₄);
α-Cs₃(HSO₄)₂(H₂PO₄);
CsHSO₄;
Ba₂YsnO_{5.5};
SnO₂.2H₂O;
Sb₂O₅.5.4H₂O;
H₂Ti₄O₉.1.2H₂O;
HUO₂AsO₄.4H₂O;
HUO₂PO₄.4H₂O;
H₃Sb₃P₂O₁₄.10H₂O;
HSbP₂O₈.nH₂O;
H₂Sb₄O₁₁.3H₂O;
HsbO₃.2H₂O; and a combination thereof.

9. The membrane as defined in claim 1, wherein the proton conductive filler is present in the form of being deposited on a support selected from the group consisting of silica, clay, alumina, mica and zeolite.

10. The membrane as defined in claim 9, wherein the proton conductive filler is phosphotungstic acid, silicotungstic acid or a combination thereof.

11. The membrane as defined in claim 9, wherein the proton conductive filler is deposited on the support in the amount of 5-50 wt % based on the weight of the support.

12. The membrane as defined in claim 1, wherein the membrane is 10-250 μm thick.

13. A method of manufacturing the composite electrolyte membrane of claim 1, comprising the following steps of:
(a) separately dissolving each of an ion exchange resin having cation exchanging groups on the side chains thereof and a non-conductive polymer resin in an organic solvent, followed by mixing the solutions together to prepare a first mixture;
(b) simultaneously or sequentially adding each of proton conductive filler of powder form and thermally curable oligomer to the first mixture to prepare a second mixture; and
(c) molding the second mixture into a molded body of film form, followed by heating the molded body of film form to evaporate the organic solvent contained therein and concurrently to perform a cross-linking reaction of thermally curable oligomer

14. The method as defined in claim 13, wherein the organic solvent is selected from the group consisting of 2-propanol, N-methyl-2-pyrrolidinone, dimethyl formamide, dimethyl acetamide, tetrahydrofuran, dimethyl sulfoxide, acetone, methyl ethyl ketone, tetramethylurea, trimethyl phosphate, butyrolactone, isophorone, carbitol acetate, methyl isobutyl ketone, N-butyl acetate, cyclohexanone, diacetone alcohol, diisobutyl ketone, ethyl acetoacetate, glycol ether, propylene carbonate, ethylene carbonate, dimethylcarbonate, diethylcarbonate, and a combination thereof.

15. The method as defined in claim 13, further comprising, before the step c), adding 0.1-5.0 wt % of an initiator based on the weight of the thermally curable oligomer, the initiator being selected from the group consisting of benzoyl peroxide, alkyl peroxides, cumene hydro-peroxide, peresters, and azo compounds.

16. The method as defined in claim 13, wherein the molding in the step c) is carried out through an extrusion molding, injection molding, doctor blade coating or thin-film casting.

17. The method as defined in claim 13, wherein the heating temperature in the step c) ranges from 50-150 C.

18. The method as defined in claim 13, further comprising d) sulfonating the non-conductive polymer in the membrane.

19. The method as defined in claim 13, wherein the non-conductive polymer is sulfonated, followed by dissolving in the organic acid during the step a).

20. The method as defined in claim 13, wherein the non-conductive polymer solution in the step a) is added with a basic component before being mixed with the ion exchange resin solution, and treated with sulfuric acid after the step c).

21. The method as defined in claim 13, wherein each of the ion exchange resin and the non-conductive polymer is dissolved in the organic solvent in the concentration of 0.5-30 wt % in the step a).

22. A method of manufacturing the composite electrolyte membrane of claim 1, comprising the following steps of:
(a) separately dissolving each of an ion exchange resin having cation exchanging groups on the side chains thereof and a non-conductive polymer resin in an organic solvent, followed by mixing the solutions together to prepare a first mixture;
(b) mixing the first mixture with a thermally curable oligomer to prepare a second mixture;
(c) molding the second mixture into a molded body of film form, followed by heating the molded body of film form to evaporate the organic solvent contained therein and concurrently to perform a cross-linking reaction by the thermally curable oligomer; and
(d) uniformly dispersing proton conductive filler of powder form in the molded body of film form via in-situ doping treatment.

23. The method as defined in claim 22, further comprising, sulfonating the non-conductive polymer before or after the step d).

24. A membrane-electrode assembly for fuel cells, comprising the composite polymer electrolyte membrane of claim 1 attached between a cathode and an anode.

25. A fuel cell comprising the membrane-electrode assembly of claim 24.

26. The fuel cell as defined in claim 25, wherein the cell comprises a laminated structure consisting of currentcollector/anode/composite polymer electrolyte membrane/cathode/current collector/anode/composite polymer electrolyte membrane/ cathode/current collector, in order; terminals connected to the anodes and the cathodes to provide fuels and oxidants thereto; and a cell case sealing around the laminated structure.
